(19) United States
(12) Patent Application Publication
(10) Pub. No.: US 2026/0049922 A1
(43) Pub. Date: Feb. 19, 2026

(54) AIR PURIFIER AND FILTER STATE DECISION METHOD OF THE AIR PURIFIER

(71) Applicant: COWAY Co., Ltd., Gongju-si (KR)

(72) Inventors: Tae Hyun KIM, Seoul (KR); Il CHU, Seoul (KR); Jin Min KIM, Seoul (KR)

(73) Assignee: COWAY Co., Ltd., Gongju-si (KR)

(21) Appl. No.: 19/291,478

(22) Filed: Aug. 5, 2025

(30) Foreign Application Priority Data
Aug. 14, 2024 (KR) 10-2024-0108746

(51) Int. Cl. G01N 15/10; B01D 46/00; B01D 46/44; B01D 46/56

(52) U.S. Cl. CPC G01N 15/10; B01D 46/0045; B01D 46/0086; B01D 46/442; B01D 46/56; B01D 2273/30; G01N 2015/1029

(57) ABSTRACT

In an air purifier and a filter state decision method of the air purifier, the air purifier includes an intake, a blower fan, a filter unit, an outlet, a dust sensor and a control unit. An air is drawn in through the intake. The blower fan is configured to provide a blowing force so that the air is drawn into the intake. The filter unit is configured to purify the air drawn through the intake. A purified air passing through the filter unit is discharged through the outlet. The dust sensor unit is configured to measure a number concentration by particle size in the air. The control unit is configured to generate filter management information of the filter unit based on the number concentration by particle size obtained from the dust sensor unit.

This application claims priority under 35 U.S.C. § 119 to Korean Patent Application No. 10-2024-0108746, filed on Aug. 14, 2024, the disclosure of which is incorporated by reference herein in its entirety.

### BACKGROUND

### 1. Field of Disclosure

The present disclosure of invention relates to an air purifier and a filter state decision method of the air purifier, and more specifically the present disclosure of invention relates to an air purifier and a filter state decision method of the air purifier, deciding the status of each filter installed in the air purifier based on dust data and providing information on replacement or cleaning of each filter.

### 2. Description of Related Technology

In maintaining the performance of an air purifier, it is very important to determine the condition of the filter and to perform replacement or cleaning at an appropriate time. Accordingly, even in conventional air purifiers, technologies have been developed to provide relevant information, such as by providing an external alarm when the filter needs to be replaced or cleaned.

However, in conventional methods, the decision of whether to replace the filter was merely based on the passage of a predetermined period of time, as in the technology disclosed in Korean Patent No. 10-0482788, which guides the user to replace the filter when the motor's operation time reaches a certain threshold.

Of course, as disclosed in Korean Patent No. 10-0819077, a technology has also been developed that indicates the timing of filter replacement based on odors emitted from substances adsorbed on the filter, in addition to the mere passage of time.

However, such decisions of the filter replacement timing are based only on indirect indicators, such as elapsed time or odors, and thus fail to accurately reflect information about the actual air pollution level or the condition of the filter. As a result, filters may be overused beyond their effective lifespan or unnecessarily replaced. In particular, there is also a problem in that the replacement timing is not provided separately for each type of filter.

### SUMMARY

The present invention is developed to solve the above-mentioned problems of the related arts. The present invention provides an air purifier capable of more accurately deciding the status of the filter based on the accumulated dust amount derived using information on the size of actual air dust particles, and individually providing information on the status of each filter.

In addition, the present invention also provides a filter state decision method of the air purifier.

According to an example embodiment, the air purifier includes an intake, a blower fan, a filter unit, an outlet, a dust sensor and a control unit. An air is drawn in through the intake. The blower fan is configured to provide a blowing force so that the air is drawn into the intake. The filter unit is configured to purify the air drawn through the intake. A purified air passing through the filter unit is discharged through the outlet. The dust sensor unit is configured to measure a number concentration by particle size in the air. The control unit is configured to generate filter management information of the filter unit based on the number concentration by particle size obtained from the dust sensor unit. The control unit includes a number concentration acquisition unit configured to acquire the number concentration by particle size from the dust sensor unit, an operation information acquisition unit configured to acquire operation information of the blower fan, a dust information acquisition unit configured to acquire information on a dust amount by particle size based on the number concentration by particle size and the operation information, and an information providing unit configured to provide the filter management information of the filter unit based on the information on the amount of dust.

In an example, the dust information acquisition unit may include a first dust information unit configured to acquire a cumulative dust amount as the information on the amount of dust. The first dust information unit may be configured to acquire the cumulative dust amount by summing a dust weight by particle size obtained using a collection efficiency by particle size.

In an example, the information providing unit may include a first decision unit configured to provide filter management information of the filter unit based on the cumulative dust amount. The first decision unit may be configured to determine whether a removal efficiency corresponding to the cumulative dust amount meets a management criterion of the filter unit.

In an example, the filter unit may include a plurality of filters, and management information is provided for each filter. The number concentration by particle size of a first filter of the filter unit may be obtained from the dust sensor unit, and the number concentration by particle size of a second filter of the filter unit may be obtained based on the number concentration by particle size and the collection efficiency of the first filter.

In an example, the dust information acquisition unit may include a second dust information unit configured to acquire real-time dust amount as the information on the amount of dust. The second dust information unit may display the real-time dust amount as a graph.

In an example, the information providing unit may include a second decision unit configured to provide filter management information for each filter based on the real-time dust amount. The second decision unit may be configured to extract a specific section from the graph of the real-time dust amount and to provide management information of the filter unit. In an example, the second decision unit may be configured to select a specific particle

in the extracted specific section, to calculate purification capacity for the specific particle based on reference data, and to provide the management information of the filter unit.

According to another example embodiment, in a method for deciding a filter state of an air purifier, the method includes acquiring a number concentration by particle size from a dust sensor unit, receiving operation information of a blower fan, acquiring information on a dust amount by particle size based on the number concentration by particle size and the operation information, and providing management information of a filter unit based on the information on the dust amount.

In an example, acquiring the number concentration by particle size may include acquiring the number concentration by particle size of a first filter of the filter unit from the dust sensor unit, receiving information on collection efficiency of the first filter, and acquiring the number concentration by particle size of a second filter of the filter unit based on the number concentration by particle size and the collection efficiency of the first filter.

In an example, the first filter may include a pre-filter, the second filter may include a functional filter, and a third filter may include a dust-collecting filter.

In an example, acquiring the information on the dust amount may include acquiring a cumulative dust amount as the information on the dust amount.

In an example, acquiring the information on the dust amount may include acquiring a mass concentration by particle size from the number concentration by particle size, acquiring an inflow weight by particle size, considering the operation information of the blower fan, acquiring a dust weight by particle size reflecting the collection efficiency from the inflow weight by particle size, and acquiring the cumulative dust amount from the dust weight by particle size.

In an example, acquiring the inflow weight by particle size may include considering airflow and operation time as the operation information of the blower fan.

In an example, acquiring the dust weight by particle size may include applying pre-stored collection efficiency by particle size to the inflow weight by particle size.

In an example, acquiring the cumulative dust amount may include summing the dust weight by particle size derived for each particle to obtain the cumulative dust amount.

In an example, providing the filter management information for each filter may include applying pre-stored removal efficiency corresponding to the cumulative dust amount to obtain a removal efficiency of each filter from the acquired cumulative dust amount.

In an example, acquiring the information on the dust amount may include acquiring a real-time dust amount as the information on the dust amount.

In an example, providing the filter management information for each filter may include extracting a decrease section from a graph of the real-time dust amount, selecting a target particle from the decrease section, calculating purification capacity based on a decrease state of the selected particle, and providing the filter management information based on the purification capacity.

In an example, extracting the decrease section may include extracting a decrease section having a specific learned trend from the graph of the real-time dust amount.

In an example, selecting the target particle may include applying a learned result regarding a method of selecting a target particle from the decrease section.

In an example, calculating the purification capacity may include regarding an initially measured purification capacity as reference data, and calculating the purification capacity at a selected time compared to the reference data.

In an example, the purification capacity (P) may be calculated by the following Equation (4):

$$P = \frac{V}{{N}_{t}} ln ( \frac{{C}_{i 2}}{{C}_{t 2}} ) - ln ( \frac{{C}_{i 1}}{{C}_{t 1}} ) \qquad Equation ( 4 )$$

where V may be the volume of clean air in the installation space of the air purifier, Nₜ may be the total number of particles during the operation period of the air purifier, Cᵢ₁ may be the particle concentration before starting the operation of the air purifier, Cᵢ₂ may be the particle concentration after starting the operation, Cₜ₁ may be the time before starting the operation, and Cₜ₂ may be the time after starting the operation.

According to the present example embodiments, by obtaining information about the amount of dust based on the number concentration by particle size acquired by the dust sensor unit and the operation information of the blower fan, filter management information for the filter unit may be provided. As a result, more accurate information about the condition of the filter unit is delivered, enabling the provision of precise replacement or cleaning timing for each filter in the filter unit.

At this time, the dust sensor unit senses the number concentration by particle size at the first filter of the filter unit, thereby acquiring information on the dust collection efficiency of the first filter. Based on this, it is possible to derive the particle size-specific number concentrations at the second filter, and further at the third filter, thereby providing individual management information for each filter. That is, based on the sensing results of the dust sensor unit, it becomes possible to ultimately provide management information specific to each type of filter and to determine the precise replacement and cleaning timing for each filter.

Meanwhile, as information on the amount of dust, either cumulative dust amount or real-time dust amount may be acquired to provide individual management information for each filter, making it possible to provide more accurate replacement and cleaning timing based on various types of information.

In particular, when using the cumulative dust amount, the cumulative dust amount may be obtained through predetermined automated calculations from the number concentration by particle size of each filter, enabling faster and more accurate decision of the replacement and cleaning timing of the filters.

In addition, in obtaining the cumulative dust amount, by taking into account the airflow and operation time as the operation information of the blower fan, the characteristic that the filter's lifespan varies depending on the operating conditions of the air purifier is considered, making it possible to provide even more accurate replacement and cleaning timing for the filters.

On the other hand, when using the real-time dust amount, the replacement and cleaning timing may be provided quickly and accurately in real time using artificial intelligence, by extracting a decrease section from a pre-stored real-time dust amount graph, selecting target particles to analyze based on a learned result, and deriving filter management information from the real-time dust amount.

At this time, when calculating the purification capacity to derive the filter management information, by applying a previously established purification capacity calculation formula, it is possible to quickly and accurately derive the purification capacity at a given point in time by comparing it with reference data.

### BRIEF DESCRIPTION OF THE DRAWINGS

FIG. 1 is a block diagram illustrating an air purifier according to an example embodiment of the present invention;

FIG. 2 is a block diagram illustrating a dust sensor unit and a control unit of FIG. 1;

FIG. 3 is a block diagram illustrating a first dust information unit of FIG. 2;

FIG. 4 is a block diagram illustrating a number concentration acquisition unit of FIG. 2 and a computation state of a number concentration for each filter in the number concentration acquisition unit;

FIG. 5 is a flowchart illustrating a method for deciding a filter state of the air purifier of FIG. 1;

FIG. 6 is a flowchart illustrating a step of acquiring cumulative dust amount in FIG. 5;

FIG. 7 is a flowchart illustrating a step of acquiring a number concentration by particle size in FIG. 5;

FIG. 8 is a block diagram illustrating a dust sensor unit and a control unit in an air purifier according to another example embodiment of the present invention;

FIG. 9 is a block diagram illustrating a second decision unit of FIG. 8;

FIG. 10 is a flowchart illustrating a method for deciding a filter state of the air purifier of FIG. 8;

FIG. 11 is a flowchart illustrating a step of providing filter management information based on real-time dust amount in FIG. 10; and

FIG. 12A is an example graph illustrating real-time dust amount divided into sections in FIG. 10, and FIG. 12B is a graph illustrating a step of extracting a decrease section from the real-time dust amount graph of FIG. 12A and selecting target particles for analysis.

### DETAILED DESCRIPTION

The invention is described more fully hereinafter with Reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed as a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the invention is described more fully hereinafter with reference to the accompanying drawings, in which embodiments of the invention are shown.

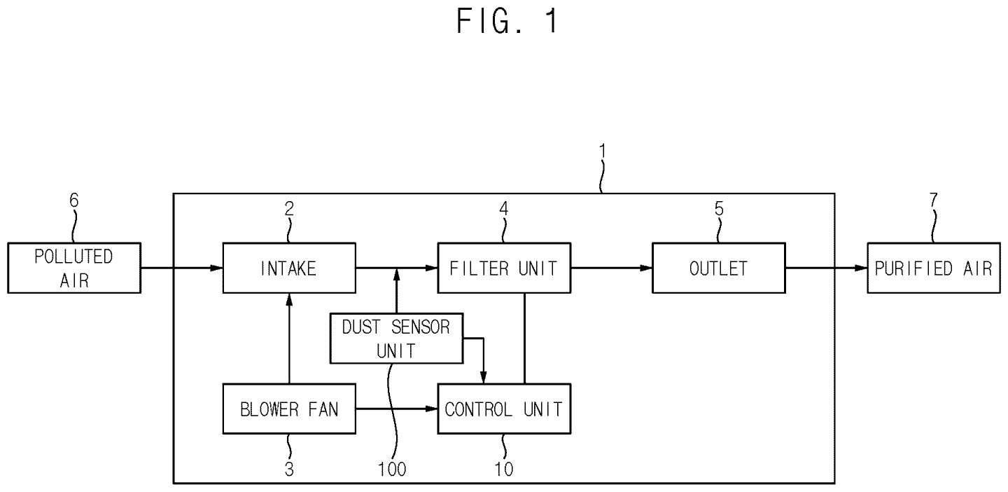

FIG. 1 is a block diagram illustrating an air purifier according to an example embodiment of the present invention.

Referring to FIG. 1, the air purifier 1 according to the present example embodiment includes an intake 2, a blower fan 3, a filter unit 4, an outlet 5, a control unit 10, and a dust sensor unit 100.

The intake 2 is an inlet through which an air, that is, a polluted air 6, is drawn in from the outside, and the blower fan 3 provides a predetermined blowing force so that the air is drawn into the intake 2.

Accordingly, the air drawn through the intake 2 is delivered to the filter unit 4 and filtered. At this time, the filter unit 4 includes a plurality of filters, and the filters included in the filter unit 4 may include, for example, a pre-filter, a functional filter, and a dust collection filter. Hereinafter, for convenience of explanation, a first filter is described as the pre-filter, a second filter as the functional filter, and a third filter as the dust collection filter, but, the first to third filters are not necessarily limited to these types, and the number of filters included in the filter unit 4 is not necessarily limited to three.

The pre-filter filters relatively large dust particles and is positioned at the outermost side of the filter unit 4, that is, at the position where the pre-filter first comes into contact with the polluted air 6. The pre-filter may be used semi-permanently without replacement and is a filter that requires periodic cleaning. The functional filter may be provided downstream of the pre-filter and is a filter that performs special functions such as removing fine dust, providing antibacterial effects, or deodorizing, and the functional filter requires periodic replacement. The dust collection filter may be provided downstream of the functional filter and adsorbs fine dust using static electricity, thereby removing ultrafine dust and various harmful bacteria. The dust collection filter, like the functional filter, is a filter that requires periodic replacement.

Meanwhile, as described above, the purified air 7 purified through the filter unit 4 is discharged to the outside through the outlet 5, and thus the space where the air purifier 1 is installed is purified.

The control unit 10 generates filter management information of the filter unit 4 using the number concentration by particle size acquired from the dust sensor unit 100.

The dust sensor unit 100 measures the number concentration by particle size of the dust contained in the air delivered to the filter unit 4 through the intake 2, and the dust sensor unit 100 may include a single dust sensor, or alternatively, it may include a plurality of dust sensors.

When the dust sensor unit 100 includes a single dust sensor, as described later, when the filter unit 4 includes a plurality of filters, it is sufficient to acquire the number concentration by particle size of the air entering the first filter of the filter unit 4.

Alternatively, when the dust sensor unit 100 includes a plurality of dust sensors, the dust sensors are provided at each of the plurality of the filters included in the filter unit 4 so that the number concentration by particle size of the air entering each filter may be acquired.

The blower fan 3 provides a predetermined blowing force so that the polluted air 6 is effectively drawn into the intake 2. At this time, the blower fan 3 may control its blowing force by itself based on the pollution state of the air, or the blowing force may also be controlled by the user's selection.

At this time, the amount of polluted air 6 delivered to the filter unit 4 varies depending on the blowing force and operation time of the blower fan 3, and consequently, the lifetime of the filters in the filter unit 4 is affected by the blowing force and operation time of the blower fan 3.

Therefore, as operation information of the blower fan 3, information on the airflow and operation time of the blower fan must be provided to the control unit 10.

That is, the control unit 10 generates management information for each of the filters included in the filter unit 4 based on the number concentration by particle size information acquired from the dust sensor unit 100 and the information on airflow and operation time as the operation information of the blower fan 3.

Hereinafter, the specific configuration and operation of the control unit 10 will be described.

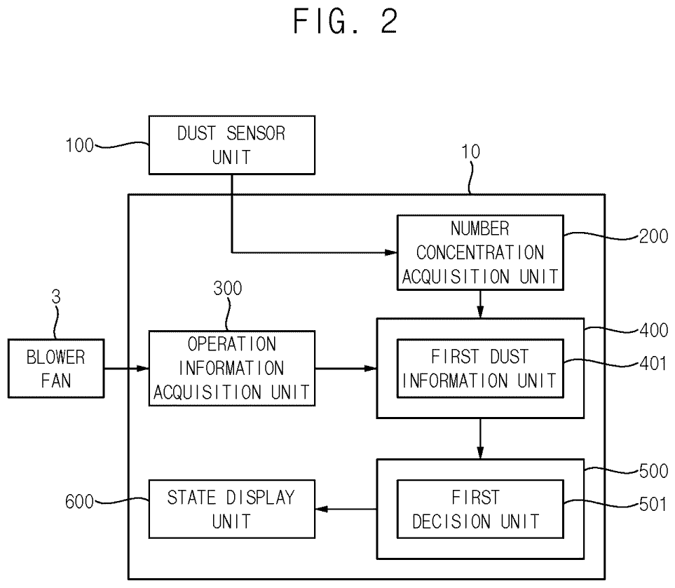

FIG. 2 is a block diagram illustrating a dust sensor unit and a control unit of FIG. 1.

Referring to FIG. 2, the control unit 10 includes a number concentration acquisition unit 200, an operation information acquisition unit 300, a dust information acquisition unit 400, an information providing unit 500, and a state display unit 600.

The number concentration acquisition unit 200 acquires the number concentration by particle size from the dust sensor unit 100. At this time, the number concentration by particle size refers to the concentration of the number of particles according to the size of each dust particle. That is, depending on the size of the dust particle, the number of particles of that size per unit volume is indicated, and the unit may be [counts/0.1 L]. This unit is merely to explain the concept of number concentration, and depending on the type of the dust sensor unit 100 or other factors, number concentration in various units may be acquired. However, hereinafter, for convenience of explanation, [counts/0.1 L] is used as the most typical unit of number concentration by particle size.

In addition, the size of the dust particles may be classified in various ways, for example, into 0.3 μm, 0.5 μm, 1.0 μm, 2.5 μm, 5.0 μm, and 10.0 μm. Of course, the classification of the dust particle size may also vary in various ways.

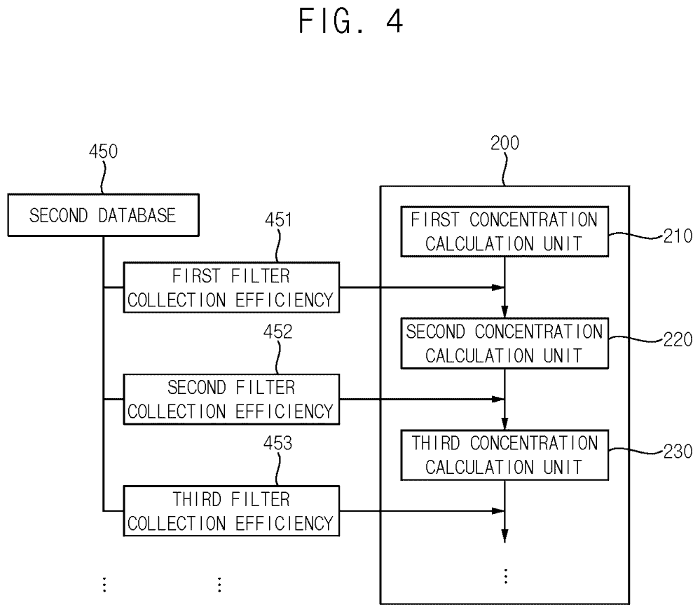

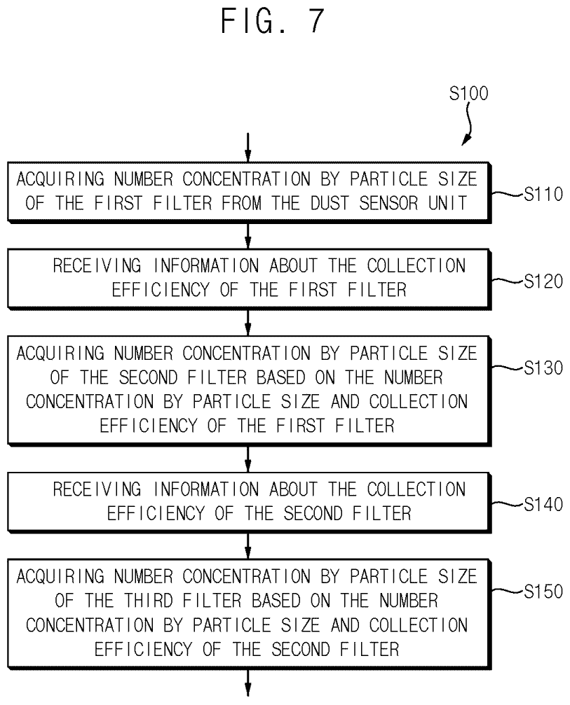

At this time, the detailed method of acquiring the number concentration of each dust particle size in the number concentration acquisition unit 200 will be described later with reference to FIG. 4 and FIG. 7.

The operation information acquisition unit 300 acquires the operation information of the blower fan 3, and as the operation information of the blower fan 3, for example, information on the airflow and operation time of the blower fan 3 may be acquired.

As described above, since the amount of polluted air 6 actually filtered by the filter unit 4 varies depending on the airflow and operation time of the blower fan 3, the lifespan of each filter of the filter unit 4 also varies. Therefore, the operation information acquisition unit 300 acquires the operation information of the blower fan 3 to enable the filter management information of the filter unit 4 to be generated more accurately.

The dust information acquisition unit 400 includes a first dust information unit 401. The first dust information unit 401 acquires information on the dust amount by particle size based on the information on the number concentration by particle size acquired through the number concentration acquisition unit 200 and the operation information of the blower fan 3 acquired from the operation information acquisition unit 300.

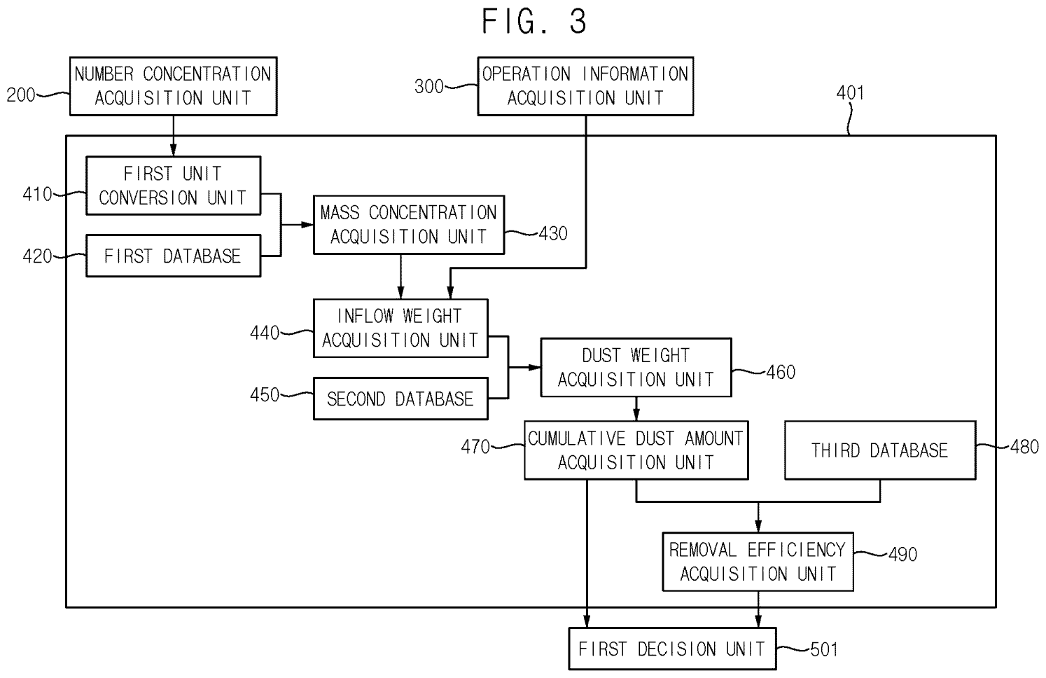

At this time, a more detailed description of acquiring the information on the dust amount by particle size in the dust information acquisition unit 400 will be given later with reference to FIG. 3.

The information providing unit 500 includes a first decision unit 501. The first decision unit 501 provides the filter management information of the filter unit 40 based on the information on the dust amount by particle size or the cumulative dust amount information acquired by the dust information acquisition unit 400. Since the filter unit 40 may include a plurality of filters, the information providing unit 500 provides individual filter management information for each of the filters included in the filter unit 40.

Accordingly, information on filters that may continue to be used, information on filters that require cleaning, and information on filters that require replacement are provided as the filter management information.

The state display unit 600 displays to the outside the individual filter management information acquired for each of the filters by the first decision unit 501. The state display unit 600, although not shown, may be provided in the form of a display on the exterior of the air purifier 1 and presents to the user the information of each of the filters mounted in the air purifier 1 and the management information of each filter.

At this time, the management information of the filters may include, as exemplified above, whether each filter is usable, whether cleaning is required, and whether replacement is required. Based on the display content of the state display unit 600, the user may perform individual management for each filter.

FIG. 3 is a block diagram illustrating a first dust information unit of FIG. 2.

Referring to FIG. 3, the first dust information unit 401 is described in detail as follows.

As described above, the first dust information unit 401 acquires information on the dust amount by particle size based on the information on the number concentration by particle size obtained through the number concentration acquisition unit 200 and the operation information of the blower fan 3 obtained from the operation information acquisition unit 300. Furthermore, the first dust information unit 401 acquires information on the cumulative dust amount based on the information on the dust amount by particle size.

The acquisition of the dust amount by particle size and the cumulative dust amount in the first dust information unit 401 is performed for each of the plurality of filters included in the filter unit 4 so that information on the cumulative dust amount for each filter may be ultimately obtained.

More specifically, the first dust information unit 401 includes a first unit conversion unit 410, a first database 420, a mass concentration acquisition unit 430, an inflow weight acquisition unit 440, a second database 450, a dust weight acquisition unit 460, a cumulative dust amount acquisition unit 470, a third database 480, and a removal efficiency acquisition unit 490.

The first unit conversion unit 410 converts the unit of the number concentration by particle size of the dust provided from the number concentration acquisition unit 200. That is, as previously explained, the number concentration by particle size is most commonly expressed in the unit of [counts/0.1 L]. Accordingly, the first unit conversion unit 410 converts the unit [counts/0.1 L] into [counts/m³]. Such unit conversion may be implemented through a simple calculation. At this time, since the particle sizes may be classified in various ways, the number concentration in each particle size is converted as described above.

Of course, if the unit of the number concentration by particle size of the dust provided from the number concentration acquisition unit 200 is already provided in [counts/m³], the separate unit conversion through the first unit conversion unit 410 may be omitted.

After the unit of the number concentration by particle size of the dust is converted into [counts/m³] by the first unit conversion unit 410 as described above, the mass concentration acquisition unit 430 converts the number concentration by particle size into a mass concentration by particle size based on the information on the weight per particle stored in the first database 420.

That is, in order to derive the mass concentration by particle size of the dust, it is necessary to multiply the number concentration by particle size of the dust by the weight per particle. Here, the mass concentration by particle size is derived in the unit of [μg/m³], and the weight per particle has the unit of [μg/count]. The derivation of the mass concentration by particle size is performed as shown in Equation (1) below.

$$( Equation 1 )$$

$$[ Mass concentration by particle size , \text{} μ g / {m}^{3} ] = [ Number concentration by particle size , \text{} counts / {m}^{3} ] \times [ Weight per particle , μ g / count ]$$

By converting the simple number concentration into the unit of mass concentration as described above, the information on the dust amount may ultimately be derived in the unit of [g], and thus this calculation in the mass concentration acquisition unit 430 is essential.

Meanwhile, the information on the weight per particle is stored in advance in the first database 420. That is, as previously illustrated, for each of the dust particle sizes classified into 0.3 μm, 0.5 μm, 1.0 μm, 2.5 μm, 5.0 μm, and 10.0 μm, the information on the weight of a dust particle having a specific size is either pre-measured or pre-stored, and such data is stored in the first database 420 in advance.

Thus, as shown in Equation (1), the mass concentration acquisition unit 430 multiplies the number concentration by particle size of the dust by the weight per particle to ultimately acquire the mass concentration by particle size of the dust.

Next, the inflow weight acquisition unit 440 acquires the weight of the dust that actually flows into the inside of the filter unit 4 for each particle size of the dust, based on the information on the mass concentration by particle size obtained from the mass concentration acquisition unit 430 and the operation information of the blower fan 3 provided through the operation information acquisition unit 300.

At this time, as described above, the operation information of the blower fan 3 includes information on the air volume and the operation time of the blower fan 3. The air volume information has the unit of [m³/hr], meaning the amount of air blown per hour, and the operation time information means the operation time of the blower fan 3 in the unit of [hr].

That is, the inflow weight acquisition unit 440 multiplies the mass concentration by particle size [μg/m³] by the air volume [m³/hr] and the operation time [hr] of the blower fan 3 to ultimately acquire the inflow weight of the dust into the inside of the filter unit 4 for each particle size of the dust in the unit of [μg] as shown in Equation (2) below.

$$( Equation 2 )$$

$$[ Inflow weight by particle size , μg ] \text{} = [ Mass concentration by particle size , μg / {m}^{3} ] \times [ Air volume , \text{} {m}^{3} / hr ] \times [ Operation time , hr ]$$

Next, the dust weight acquisition unit 460 acquires the dust weight by particle size in which the collection efficiency is reflected, based on the inflow weight by particle size of the dust. At this time, in order to reflect the collection efficiency, the data on the collection efficiency by particle size of the dust stored in the second database 450 is utilized.

That is, as previously described, in the first database 420, the information on the weight per particle for each particle size of the dust is stored in advance. That is, in the case of the first database 420, for each of the dust particle sizes classified into 0.3 μm, 0.5 μm, 1.0 μm, 2.5 μm, 5.0 μm, and 10.0 μm, the information on the weight of dust particle having a specific size is stored in advance.

Similarly, in the second database 450, the information on the collection efficiency by particle size of the dust is pre-measured or pre-stored based on literature. That is, for each of the dust particle sizes classified into 0.3 μm, 0.5 μm, 1.0 μm, 2.5 μm, 5.0 μm, and 10.0 μm, the information on the collection efficiency of dust having a specific size is stored in advance.

At this time, since the collection efficiency of the dust may vary depending on each individual filter constituting the filter unit 4, the information on the collection efficiency by particle size of the dust must be stored for each filter. Such collection efficiency of the dust means the efficiency of collecting dust and has the unit of [%].

That is, as shown in Equation (3) below, the dust weight acquisition unit 460 may derive the dust weight by particle size in which the collection efficiency is reflected based on the content stored in the second database 450.

$$( Equation 3 )$$

$$[ Inflow weight by particle size with collection efficiency reflected , \text{} μg ] = [ Inflow weight by particle size , μg ] \times [ Collection efficiency , \% ]$$

The cumulative dust amount acquisition unit 470 ultimately acquires the cumulative dust amount accumulated in each of the filters of the filter unit 4 based on the inflow weight by particle size with the collection efficiency reflected obtained from the dust weight acquisition unit 460.

The inflow weight obtained from the dust weight acquisition unit 460 is acquired for each particle size of the dust, for example, the inflow weight for each of the dust particle sizes classified into 0.3 μm, 0.5 μm, 1.0 μm, 2.5 μm, 5.0 μm, and 10.0 μm.

Therefore, the cumulative dust amount acquisition unit 470 sums the inflow weights of all the dust particles for each of the filters included in the filter unit 4 to ultimately acquire the cumulative dust amount for each filter. That is, by summing the inflow weights for each of the dust particle sizes classified into 0.3 μm, 0.5 μm, 1.0 μm, 2.5 μm, 5.0 μm, and 10.0 μm, the total cumulative dust amount for all types of dust particle sizes is obtained. At this time, the acquired cumulative dust amount may be in the unit of [μg], but considering the total amount of the cumulative dust amount, it may be converted into [g] or other units.

Thus, the cumulative dust amount accumulated in each of the filters included in the filter unit 4 may be acquired.

Furthermore, the information on the cumulative dust amount for each filter, as derived as described above, is directly provided to the first decision unit 501, and the first decision unit 501 provides the filter management information for each filter.

That is, the first decision unit 501 determines whether cleaning or replacement is necessary by comparing the cumulative dust amount information accumulated in each of the filters of the filter unit 4 with a reference cumulative dust amount. Here, the reference cumulative dust amount may be defined as the maximum cumulative dust amount at which each filter can operate normally, but the definition of the reference cumulative dust amount may vary as needed.

As exemplified above, if the filters included in the filter unit 4 are the pre-filter, the functional filter, and the dust-collecting filter, the first decision unit 501 determines whether cleaning or replacement is necessary by comparing the cumulative dust amounts of the pre-filter, the functional filter, and the dust-collecting filter with their respective reference cumulative dust amounts. At this time, it is evident that the reference cumulative dust amount may be defined differently depending on the type of each filter.

Accordingly, if the cumulative dust amount accumulated in the pre-filter is greater than the reference cumulative dust amount for the pre-filter, the first decision unit 501 determines that cleaning of the pre-filter is required. If the cumulative dust amount accumulated in the functional filter is greater than the reference cumulative dust amount for the functional filter, the first decision unit 501 determines that replacement of the functional filter is required. Likewise, if the cumulative dust amount accumulated in the dust-collecting filter is greater than the reference cumulative dust amount for the dust-collecting filter, the first decision unit 501 determines that replacement of the dust-collecting filter is required.

Alternatively, the first decision unit 501 may provide the filter management information for each filter based on removal efficiency additionally obtained based on the cumulative dust amount.

That is, the removal efficiency acquisition unit 490 acquires the removal efficiency for each filter from the cumulative dust amount of each filter obtained by the cumulative dust amount acquisition unit 470.

At this time, the removal efficiency acquisition unit 490 utilizes information on pre-stored removal efficiency corresponding to cumulative dust amount, which is stored in the third database 480. Specifically, the third database 480 pre-stores the relationship between cumulative dust amount and removal efficiency for each of the filters. This is because the relationship between the dust amount accumulated in each filter and the corresponding removal efficiency may be predetermined according to the characteristics of each filter.

Therefore, by applying the relationship between cumulative dust amount and removal efficiency to the cumulative dust amount obtained by the cumulative dust amount acquisition unit 470, the removal efficiency acquisition unit 490 may acquire information on the current dust removal efficiency of each of the filters.

When the information on the dust removal efficiency of each filter is provided to the first decision unit 501, the first decision unit 501 compares the current dust removal efficiency of each of the filters of the filter unit 4 with a reference removal efficiency, and determines whether cleaning or replacement is necessary. Here, the reference removal efficiency may be defined as the minimum removal efficiency at which each filter can operate normally, but the definition of the reference removal efficiency may vary as needed.

As exemplified above, if the filters included in the filter unit 4 are the pre-filter, the functional filter, and the dust-collecting filter, the first decision unit 501 determines whether cleaning or replacement is necessary by comparing the current removal efficiency and the reference removal efficiency of the pre-filter, the functional filter, and the dust-collecting filter.

As described above, the method of acquiring the dust amount and cumulative dust amount by particle size in the first dust information unit 401, and providing the filter management information of the filter unit in the first decision unit 501, has been explained. Hereinafter, the detailed process of acquiring the number concentration by particle size for each filter of the filter unit 4 in the number concentration acquisition unit 200 will be described.

FIG. 4 is a block diagram illustrating a number concentration acquisition unit of FIG. 2 and a computation state of a number concentration for each filter in the number concentration acquisition unit.

First, referring to FIG. 4, the number concentration acquisition unit 200 acquires the number concentration by particle size from the dust sensor unit 100, as previously described, the number concentration by particle size means the concentration of the number of particles according to the size of each dust particle.

Meanwhile, the dust sensor unit 100 measures the number concentration by particle size of the dust contained in the polluted air 6, and the dust sensor unit 100 may include a single dust sensor to measure the number concentration by particle size only for the dust in the air introduced into the first filter of the filter unit 4.

That is, as described above, the single dust sensor is provided inside the air purifier 1 and may sense the number concentration by particle size of the air supplied to the first filter, which is the first to contact the polluted air 6 in the filter unit 4. In this case, if the first filter is, for example, the pre-filter, the dust sensor may measure the number concentration by particle size of the pre-filter for each of the dust particles classified above, such as 0.3 μm, 0.5 μm, 1.0 μm, 2.5 μm, 5.0 μm, and 10.0 μm.

Therefore, the number concentration by particle size of the dust in the air introduced into the second filter, which is located downstream of the first filter, must be obtained through separate calculations.

The number concentration acquisition unit 200 includes first to third concentration calculation units 210, 220 and 230, as shown in FIG. 4. Here, the first concentration calculation unit 210 does not actually perform separate calculations but simply acquires the number concentration by particle size information measured by the dust sensor unit 100.

At this time, the number concentration by particle size information obtained from the first concentration calculation unit 210 corresponds to the number concentration by particle size for the first filter (e.g., the pre-filter) of the filter unit 4.

Accordingly, the second concentration calculation unit 220 calculates the number concentration by particle size of the dust in the air introduced into the second filter, which is located downstream of the first filter, and the third concentration calculation unit 230 calculates the number concentration by particle size of the dust in the air introduced into the third filter, which is located downstream of the second filter.

Furthermore, if the filter unit 4 additionally includes a fourth filter, a fifth filter, and so on, additional concentration calculation units such as a fourth concentration calculation unit and a fifth concentration calculation unit may also be provided, although not shown.

The second concentration calculation unit 220 calculates the number concentration by particle size of the second filter by utilizing information on the first filter collection efficiency 451 stored in the second database 450.

As described earlier, the second database 450 pre-stores information on the collection efficiency by particle size, and stores the collection efficiency information of each filter in the filter unit 4.

Accordingly, by utilizing the information on the first filter collection efficiency 451 among the information on the collection efficiency by particle size stored in the second database 450, the number concentration by particle size of the dust supplied to the second filter may be derived. In other words, by removing the dust collected through the collection efficiency of the first filter from the number concentration by particle size of the dust introduced into the first filter, the number concentration by particle size of the dust introduced into the second filter may be ultimately derived.

As described above, the second concentration calculation unit 220 calculates the number concentration by particle size of the dust introduced into the second filter by applying the information on the first filter collection efficiency 451 to the number concentration by particle size of the dust introduced into the first filter obtained from the first concentration calculation unit 210.

If the second filter is, for example, the functional filter, the second concentration calculation unit 220 may calculate the number concentration by particle size of the dust supplied to the functional filter for each of the dust particles classified above, such as 0.3 μm, 0.5 μm, 1.0 μm, 2.5 μm, 5.0 μm, and 10.0 μm.

Similarly, the third concentration calculation unit 230 calculates the number concentration by particle size of the third filter by utilizing information on the second filter collection efficiency 452 stored in the second database 450.

That is, by utilizing the information on the second filter collection efficiency 452 among the information on the collection efficiency by particle size stored in the second database 450, the number concentration by particle size of the dust supplied to the third filter may be derived. In other words, by removing the dust collected through the collection efficiency of the second filter from the number concentration by particle size of the dust introduced into the second filter, the number concentration by particle size of the dust introduced into the third filter may be ultimately derived.

Therefore, if the third filter is, for example, the dust-collecting filter, the third concentration calculation unit 230 may calculate the number concentration by particle size of the dust supplied to the dust-collecting filter for each of the dust particles classified above, such as 0.3 μm, 0.5 μm, 1.0 μm, 2.5 μm, 5.0 μm, and 10.0 μm.

As described above, the number concentration acquisition unit 200 acquires information on the number concentration by particle size of the dust introduced into each of the filters included in the filter unit 4, and the information on the number concentration by particle size thus obtained is provided to the first unit conversion unit 410, as previously described.

Hereinafter, a method for deciding the filter state of the air purifier 1 according to the present example embodiment will be described.

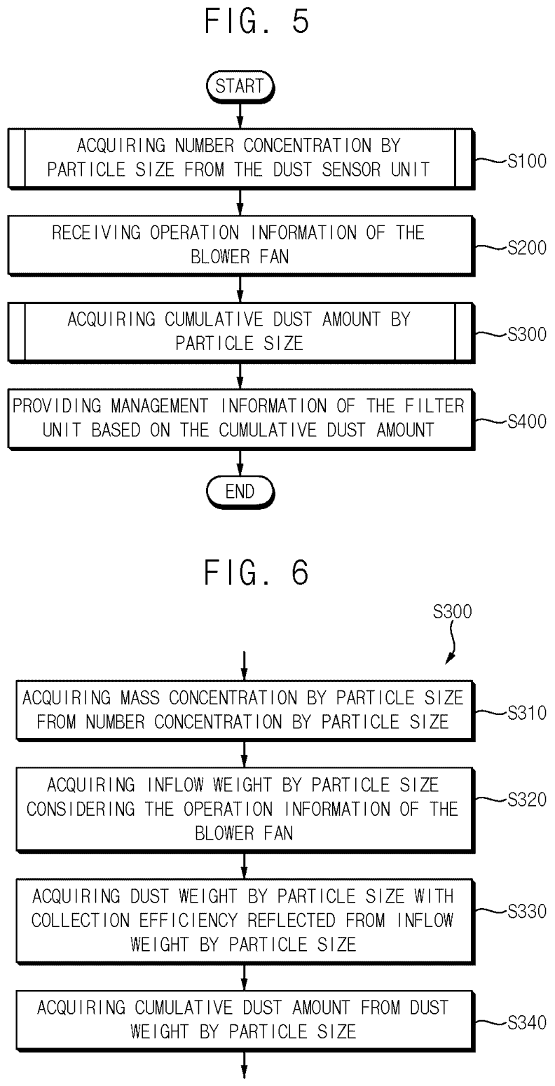

FIG. 5 is a flowchart illustrating a method for deciding a filter state of the air purifier of FIG. 1. FIG. 6 is a flowchart illustrating a step of acquiring cumulative dust amount in FIG. 5. FIG. 7 is a flowchart illustrating a step of acquiring a number concentration by particle size in FIG. 5.

First, referring to FIG. 5, in the filter state decision method of the air purifier 1, the number concentration by particle size is acquired from the dust sensor unit 100 (step S100).

At this time, referring to FIG. 7, in the step of acquiring the number concentration by particle size (step S100), first, the number concentration by particle size of the first filter of the filter unit 4 is acquired from the dust sensor unit 100 (step S110).

The dust sensor unit 100 includes a dust sensor that measures the number concentration by particle size of the dust contained in the contaminated air 6 introduced into the inlet 2 of the air purifier 1, and, as described above, the dust sensor measures the number concentration by particle size only for the dust in the air introduced into the first filter.

The number concentration by particle size information thus measured for the first filter is provided to the first concentration calculation unit 210.

Then, the second concentration calculation unit 220 receives the information 451 on the collection efficiency of the first filter stored in the second database 450 (step S120), and based on the number concentration by particle size of the first filter from the first concentration calculation unit 210 and the collection efficiency of the first filter stored in the second database 450, the number concentration by particle size of the second filter is acquired (step S130).

That is, through the second concentration calculation unit 220, the number concentration by particle size of the dust in the air introduced into the second filter is acquired.

Then, the third concentration calculation unit 230 receives the information 452 on the collection efficiency of the second filter stored in the second database 450 (step S140), and based on the number concentration by particle size of the second filter from the second concentration calculation unit 220 and the collection efficiency of the second filter stored in the second database 450, the number concentration by particle size of the third filter is acquired (step S150).

That is, through the third concentration calculation unit 230, the number concentration by particle size of the dust in the air introduced into the third filter is acquired.

Furthermore, if the filter unit 4 includes additional filters, the number concentration by particle size of each additional filter may also be calculated by applying the same calculation method.

As described above, the number concentration acquisition unit 200 acquires the number concentration by particle size of the dust contained in the air introduced into each of the filters included in the filter unit 4 based on the measurement result of the dust sensor unit 100 (step S100).

Then, referring again to FIG. 5, in the filter state decision method of the air purifier 1, the operation information acquisition unit 300 receives the operation information of the blower fan 3 (step S200).

In this case, the operation information of the blower fan 3 includes the air volume and the operation time, as previously described, and the reason why this operation information must be received has also already been explained.

Then, referring to FIG. 5, in the filter state decision method of the air purifier 1, the first dust information unit 401 included in the dust information acquisition unit 400 acquires the cumulative dust amount information of the dust by particle size as information on the dust amount, based on the number concentration by particle size and the operation information of the blower fan (step S300).

At this time, referring to FIG. 6, in the step of acquiring the cumulative dust amount by particle size (step S300), first, the mass concentration by particle size is acquired from the number concentration by particle size in the mass concentration acquisition unit 430 (step S310).

However, before acquiring the mass concentration by particle size, as described above, the unit of the number concentration by particle size may be converted to a unit such as [counts/m³] through the first unit conversion unit 410.

Accordingly, the mass concentration acquisition unit 430 acquires the mass concentration by particle size by multiplying the number concentration by particle size, whose unit has been converted, by the weight per individual particle. At this time, the information on the weight per individual particle is stored in the first database 420, and the calculation of the mass concentration acquisition unit 430 is performed through Equation (1), as described above.

Then, referring to FIG. 6, the inflow weight acquisition unit 440 acquires the inflow weight by particle size, taking into account the operation information of the blower fan 3 (step S320).

That is, the inflow weight acquisition unit 440 acquires the actual weight of the dust introduced into the inside of the filter unit 4 for each particle size of the dust, based on the information on the mass concentration by particle size of the dust obtained from the mass concentration acquisition unit 430 and the operation information of the blower fan 3 provided through the operation information acquisition unit 300. This calculation of the inflow weight by particle size is performed through Equation (2), as previously described.

Then, referring to FIG. 6, the dust weight acquisition unit 460 acquires the dust weight by particle size reflecting the collection efficiency from the inflow weight by particle size (step S330).

That is, the dust weight acquisition unit 460 acquires the dust weight reflecting the collection efficiency for each particle size of the dust, utilizing the data on the collection efficiency by particle size of each dust stored in the second database 450 to reflect the collection efficiency. At this time, the information on the collection efficiency by particle size stored in the second database 450 is as described above, and the dust weight by particle size is also calculated through Equation (3), as previously described.

Then, referring to FIG. 6, the cumulative dust amount acquisition unit 470 ultimately acquires the cumulative dust amount from the dust weight by particle size (step S340).

That is, the cumulative dust amount acquisition unit 470 acquires the cumulative dust amount accumulated in each of the filters of the filter unit 4, based on the dust weight by particle size reflecting the collection efficiency obtained from the dust weight acquisition unit 460. At this time, the cumulative dust amount means the total cumulative dust amount regardless of the particle size accumulated in the corresponding filter.

As described above, the first dust information unit 401 acquires the cumulative dust amount of the dust by particle size as the information on the dust amount (step S300).

Then, referring again to FIG. 5, in the filter state decision method of the air purifier 1, the first decision unit 501 provides the filter management information of the filter unit 4 based on the cumulative dust amount information acquired from the first dust information unit 401.

That is, the first decision unit 501 may determine the necessity of replacement or cleaning by comparing the information on the total cumulative dust amount accumulated in each of the filters of the filter unit 4 with the reference cumulative dust amount. Alternatively, the first decision unit 501 may also provide the filter management information of each filter by using the removal efficiency additionally acquired based on the cumulative dust amount information.

At this time, since an example of providing the filter management information of each filter in the first decision unit 501 has already been described in detail with reference to FIG. 3 above, redundant description is omitted here.

Thus, as described above, through the first decision unit 501, the filter management information of each filter included in the filter unit 4 is provided (step S400), and the filter state decision method of the air purifier 1 is completed based on the filter management information. Furthermore, the filter management information is provided to the user through the state display unit 600 described above, and the user performs appropriate maintenance such as replacement or cleaning.

As described above, an example embodiment in which the filter state of the air purifier is determined by acquiring the so-called cumulative dust amount as the information on the dust amount has been described. Hereinafter, an example embodiment in which the filter state of the air purifier is determined by acquiring the so-called real-time dust amount as the information on the dust amount will be described.

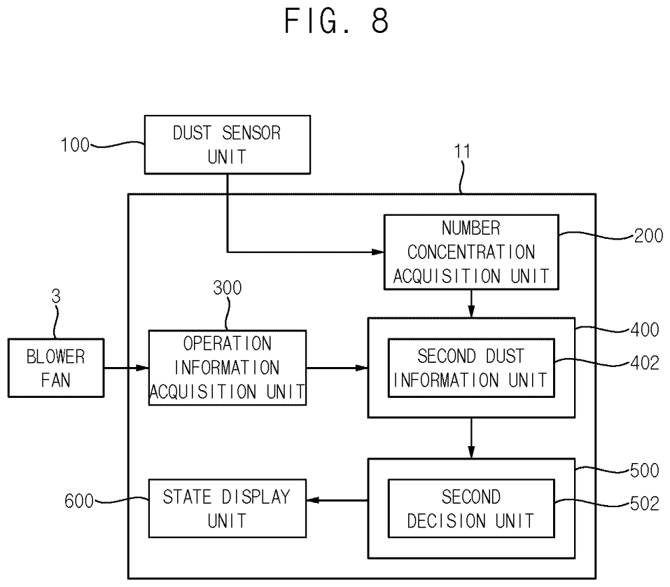

FIG. 8 is a block diagram illustrating a dust sensor unit and a control unit in an air purifier according to another example embodiment of the present invention.

The air purifier according to the present example embodiment is substantially same as the air purifier 1 described with reference to FIG. 1 and FIG. 2, except that the dust information acquisition unit 400 includes a second dust information unit 402 and the information providing unit 500 includes a second decision unit 502. Therefore, the same reference numerals are used for the same components, and any repetitive descriptions are omitted.

Referring to FIG. 8, the air purifier according to the present example embodiment also includes a control unit 11. In addition, the control unit 11 includes the number concentration acquisition unit 200 that acquires the number concentration by particle size from the dust sensor unit 100, and the operation information acquisition unit 300 that acquires the operation information of the blower fan 3.

However, the control unit 11 includes the second dust information unit 402 in the dust information acquisition unit 400, and the specific method of processing the number concentration by particle size and the operation information of the blower fan is different. In addition, the information providing unit 500 includes the second decision unit 502, and the way of providing the filter management information of the filter unit 4 based on the dust information acquired through the second dust information unit 402 is also different. At this time, the state display unit 600 displays the filter management information according to the decision result of the second decision unit 502 to the outside, and the display method is as previously described.

The specific configuration of the second dust information unit 402 and the second decision unit 502 will be described with reference to the following drawings.

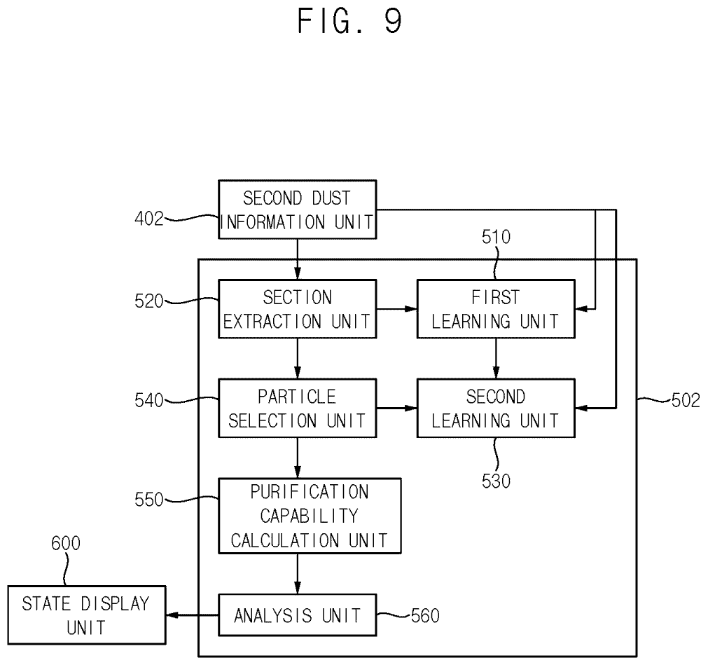

FIG. 9 is a block diagram illustrating a second decision unit of FIG. 8.

Referring to FIG. 9, the second decision unit 502 includes a section extraction unit 520, a first learning unit 510, a particle selection unit 540, a second learning unit 530, a purification capability calculation unit 550, and an analysis unit 560.

The section extraction unit 520 receives real-time dust amount information as dust amount information from the second dust information unit 402.

That is, the second dust information unit 402 receives real-time dust amount information based on the number concentration by particle size acquired from the number concentration acquisition unit 200 and the operation information of the blower fan acquired from the operation information acquisition unit 300.

As previously described with reference to FIG. 3, the number concentration acquisition unit 200 acquires the number concentration by particle size of dust in the air flowing into each of the filters included in the filter unit 4, and through predetermined calculations, acquires the inflow weight by particle size and the dust weight by particle size flowing into each of the filters.

That is, if the information on the dust weight by particle size acquired through the dust weight acquisition unit 460 is obtained over time, this may eventually be regarded as real-time dust amount information for each filter.

Therefore, the second dust information unit 402 acquires real-time dust amounts for each filter included in the filter unit 4 and provides the real-time dust amount information to the section extraction unit 520.

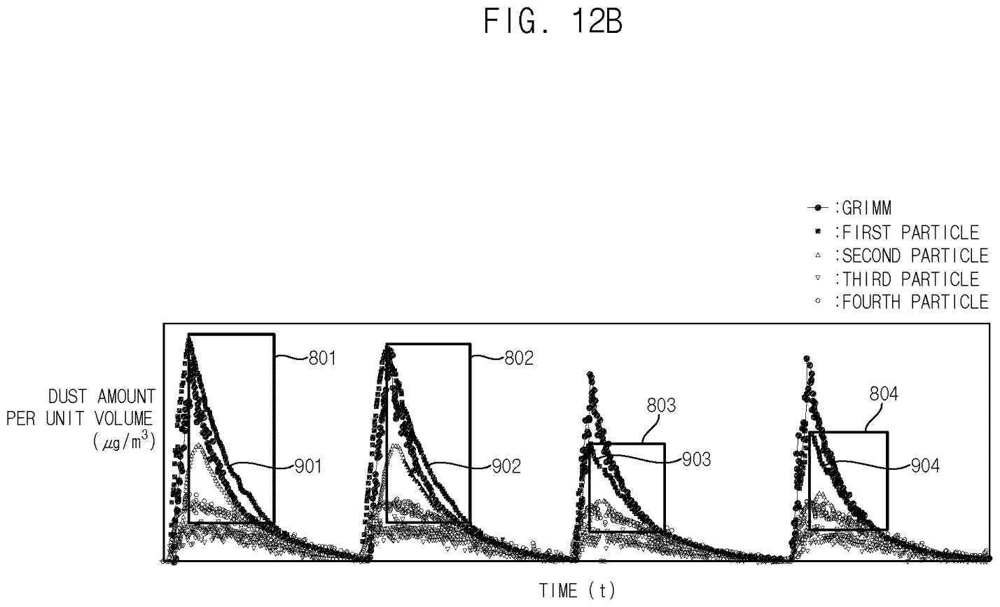

Meanwhile, the real-time dust amount information may be provided as a real-time graph that changes with time (t), as shown in FIG. 12A.

Accordingly, the section extraction unit 520 extracts a decrease section from the graph of the real-time dust amount. Here, the decrease section refers to a section where the real-time dust amount decreases over time in FIG. 12A. Since the real-time dust amount tends to periodically decrease as the air purifier 1 operates, such a decrease section occurs.

At this time, as shown in FIG. 12A, the decrease section in the real-time dust amount graph may be derived in various forms 701, 702, 703 and 704. As shown later in FIG. 12B, the section extraction unit 520 selectively extracts the decrease sections 801, 802, 803 and 804 having specific trends by utilizing the learning results of the first learning unit 510.

The decrease sections 801, 802, 803 and 804 having specific trends refers to a section where a dust contamination concentration above a certain level is detected and decreases with a certain trend, and such the section must be suitable for appropriately calculating the purification capability described later.

At this time, the first learning unit 510 repeatedly performs learning in advance to derive decrease sections with specific trends that satisfy the above conditions from various real-time dust amount graphs and stores the related learning results. Thus, sufficient information is stored on which decrease section trends may derive the purification capability more accurately and effectively. The learning of the first learning unit 510 may apply learning methods such as deep learning or machine learning.

Therefore, if the previously learned results of the first learning unit 510 are used, the section extraction unit 520 may more effectively extract the decrease sections 801, 802, 803 and 804 having specific trends.

As described above, once the decrease section with the specific trend is selected from the real-time dust amount graph, the particle selection unit 540 selects an analysis target particle from the selected decrease section.

At this time, the analysis target particle is used to calculate the purification capability based on the decrease state of the particle, and the particle that allows the purification capability to be derived more accurately and effectively must be selected.

To this end, the particle selection unit 540 may utilize the learning results of the second learning unit 530 and select the analysis target particles 901, 902, 903 and 904 as shown in FIG. 12B. For example, the analysis target particles 901, 902, 903 and 904 may include the second particles (PM 2.5 data or particles of 0.3 μm size).

At this time, the second learning unit 530 performs various learnings to select analysis target particles in the decrease sections with specific trends and stores the learning results. That is, the second learning unit 530 performs various learnings to select particles of a size that decrease clearly and with a specific trend among the various sizes of dust particles changing to a decrease state in the decrease section, so that the subsequent calculation of the purification capability may be more accurate. The learning of the second learning unit 530 may also apply learning methods such as deep learning or machine learning.

Therefore, if the previously learned results of the second learning unit 530 are used, the particle selection unit 540 may select an analysis target particle of optimal size.

The purification capability calculation unit 550 calculates the so-called purification capability based on the decrease state of the analysis target particle selected by the particle selection unit 540.

At this time, the purification capability refers to an indicator for evaluating how effectively the air purifier 1 has removed dust particles when performing air purification for a specific space. As the purification capability increases, it means that the removal of dust particles has been performed more effectively.

This purification capability P is calculated by the following Equation (4).

$$P = \frac{V}{{N}_{t}} ln ( \frac{{C}_{i 2}}{{C}_{t 2}} ) - ln ( \frac{{C}_{i 1}}{{C}_{t 1}} ) \qquad Equation ( 4 )$$

Here, V is the volume of clean air in the installation space of the air purifier, Nt is the total number of particles during the operation period of the air purifier, Ci1 is the particle concentration before starting the operation of the air purifier, Ci2 is the particle concentration after starting the operation, Ct1 is the time before starting the operation, and Ct2 is the time after starting the operation.

That is, the purification capability calculation unit 550 derives the purification capability P as in Equation (4) for the analysis target particle selected by the particle selection unit 540.

Meanwhile, when calculating the purification capability P, it is necessary to define reference data. In the present example embodiment, when deriving the purification capability P in the purification capability calculation unit 550, the initially measured purification capability is regarded as the reference data, and the purification capability at a selected time—that is, the time when evaluation is required—is calculated relative to the reference data. That is, if the initially measured purification capability is assumed to be 100% as the reference data, the purification capability at a specific time may be calculated as a percentage compared to the reference data. For example, it may be derived that, after one hour, the purification capability is 70% relative to the reference data.

The analysis unit 560 provides filter management information of the filter unit 4 based on the purification capability P calculated by the purification capability calculation unit 550. At this time, the analysis unit 560 determines the state of the filter unit 4 based on the purification capability at a specific time compared to the reference data.

Specifically, the analysis unit 560 compares the calculated result of the purification capability (e.g., 65%) with a separately provided management reference value (e.g., 70%), and if the purification capability falls below the management reference value, it determines that cleaning or replacement of the corresponding filter is necessary.

Based on this determination result of the analysis unit 560, maintenance, replacement, or cleaning of each of the filters in the filter unit 4 may be performed, thereby managing the corresponding filter.

Hereinafter, the method for deciding the filter state of the air purifier 1 according to the present example embodiment will be described with reference to FIG. 8 and FIG. 9.

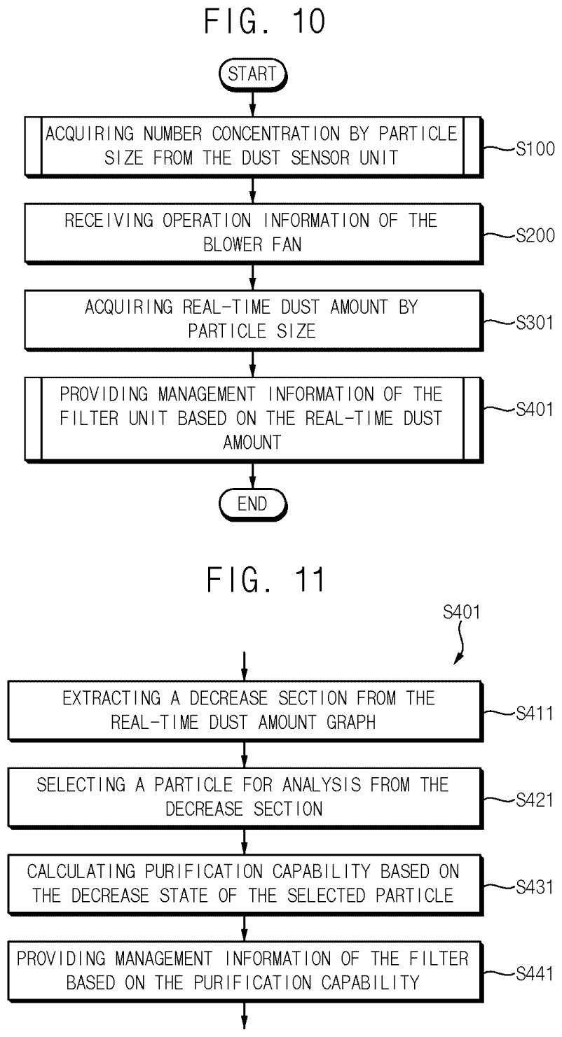

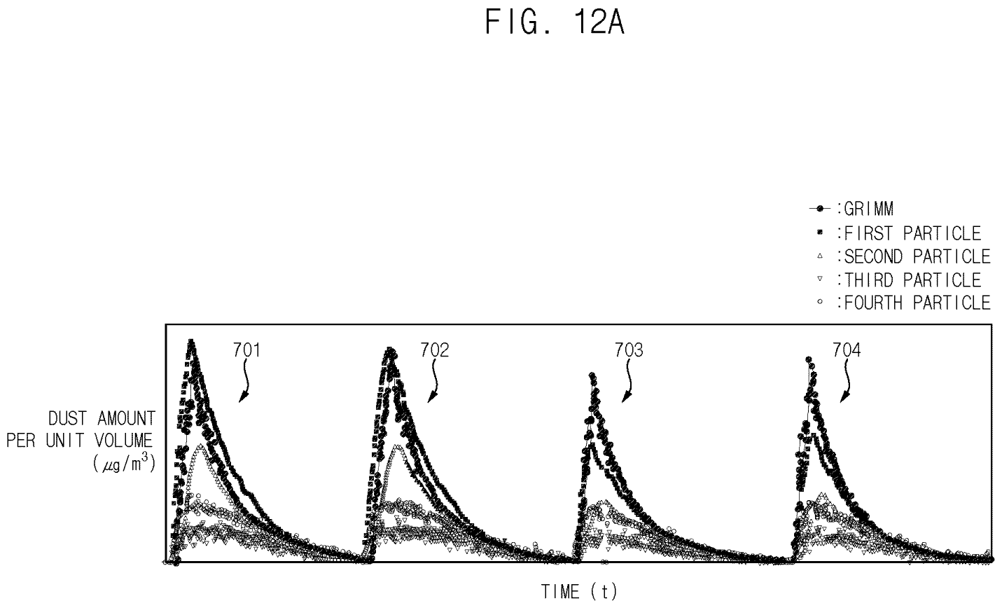

FIG. 10 is a flowchart illustrating a method for deciding a filter state of the air purifier of FIG. 8. FIG. 11 is a flowchart illustrating a step of providing filter management information based on real-time dust amount in FIG. 10. FIG. 12A is an example graph illustrating real-time dust amount divided into sections in FIG. 10, and FIG. 12B is a graph illustrating a step of extracting a decrease section from the real-time dust amount graph of FIG. 12A and selecting target particles for analysis.

First, referring to FIG. 10, in the method for deciding the filter state of the air purifier, the number concentration by particle size is obtained from the dust sensor unit 100 (step S100).

At this time, since the details of obtaining the number concentration by particle size from the dust sensor unit 100 have already been explained with reference to FIG. 7, repetitive explanation will be omitted.

That is, the number concentration acquisition unit 200 may obtain the number concentration by particle size of the dust contained in the air flowing into each of the filters included in the filter unit 4, based on the measurement result of the dust sensor unit 100.

Next, in the method for deciding the filter state of the air purifier, the operation information acquisition unit 300 may receive the operation information of the blower fan 3 (step S200). In this case, it has already been described that the operation information of the blower fan 3 is the air volume and operation time.

Next, in the method for deciding the filter state of the air purifier, the second dust information unit 402 included in the dust information acquisition unit 400 may acquire real-time dust amount information as information about the dust amount, based on the number concentration by particle size and the operation information of the blower fan (step S301).

That is, the second dust information unit 402 may acquire real-time dust amount information based on the number concentration by particle size obtained from the number concentration acquisition unit 200 and the operation information of the blower fan obtained from the operation information acquisition unit 300. As previously described, the real-time dust amount information is essentially the information of the dust weight by particle size obtained over time through the dust weight acquisition unit 460.

Next, in the method for deciding the filter state of the air purifier, the second decision unit 502 may provide management information of the filter unit 4 based on the real-time dust amount (step S401).

More specifically, referring to FIG. 11 and FIG. 12A, in the step of providing management information of the filter unit 4 (step S401), first, the section extraction unit 520 may extract the decrease sections 801, 802, 803 and 804 from the real-time dust amount graph 701, 702, 703 and 704, which is provided as a real-time graph varying with time t (step S411).

At this time, the section extraction unit 520 may selectively extract the decrease sections with a specific tendency 801, 802, 803 and 804 by utilizing the learning result of the first learning unit 510, thereby enabling more accurate and easier calculation of the purification capability to be described later.

Next, referring to FIG. 11 and FIG. 12B, the particle selection unit 540 may select analysis target particles 901, 902, 903 and 904 from the selected decreasing section (step S421).

At this time, the particle selection unit 540 may use the learning result of the second learning unit 530 to select the analysis target particles 901, 902, 903 and 904, thereby enabling more accurate calculation of the purification capability to be described later.

Meanwhile, the specific learning contents of the first and second learning units 510 and 530 have already been described above.

Next, referring to FIG. 11, the purification capability calculation unit 550 may calculate the purification capability based on the decrease state of the analysis target particle selected by the particle selection unit 540 (step S431).

At this time, the purification capability P may be calculated using Equation (4) as previously described, and the initially measured purification capability is used as the reference data. Thus, the purification capability at the selected time, that is, the time when evaluation is needed, may be calculated relative to the reference data.

Next, referring to FIG. 11, the analysis unit 560 may provide the filter management information of the filter unit 4 based on the calculation result of the purification capability (step S441).

Based on the determination result of the analysis unit 560, maintenance, replacement, or cleaning may be performed according to the state of each of the filters in the filter unit 4, thereby managing the corresponding filters.

As described above, in the present example embodiment, the management information of each individual filter of the filter unit 4 may be provided by utilizing the learning results of the learning units, that is, by using artificial intelligence.

According to the present example embodiments, by obtaining information about the amount of dust based on the number concentration by particle size acquired by the dust sensor unit and the operation information of the blower fan, filter management information for the filter unit may be provided. As a result, more accurate information about the condition of the filter unit is delivered, enabling the provision of precise replacement or cleaning timing for each filter in the filter unit.

At this time, the dust sensor unit senses the number concentration by particle size at the first filter of the filter unit, thereby acquiring information on the dust collection efficiency of the first filter. Based on this, it is possible to derive the particle size-specific number concentrations at the second filter, and further at the third filter, thereby providing individual management information for each filter. That is, based on the sensing results of the dust sensor unit, it becomes possible to ultimately provide management information specific to each type of filter and to determine the precise replacement and cleaning timing for each filter.

Meanwhile, as information on the amount of dust, either cumulative dust amount or real-time dust amount may be acquired to provide individual management information for each filter, making it possible to provide more accurate replacement and cleaning timing based on various types of information.

In particular, when using the cumulative dust amount, the cumulative dust amount may be obtained through predetermined automated calculations from the number concentration by particle size of each filter, enabling faster and more accurate decision of the replacement and cleaning timing of the filters.

In addition, in obtaining the cumulative dust amount, by taking into account the airflow and operation time as the operation information of the blower fan, the characteristic that the filter's lifespan varies depending on the operating conditions of the air purifier is considered, making it possible to provide even more accurate replacement and cleaning timing for the filters.

On the other hand, when using the real-time dust amount, the replacement and cleaning timing may be provided quickly and accurately in real time using artificial intelligence, by extracting a decrease section from a pre-stored real-time dust amount graph, selecting target particles to analyze based on a learned result, and deriving filter management information from the real-time dust amount.

At this time, when calculating the purification capacity to derive the filter management information, by applying a previously established purification capacity calculation formula, it is possible to quickly and accurately derive the purification capacity at a given point in time by comparing it with reference data.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An air purifier comprising:
an intake through which an air is drawn in;
a blower fan configured to provide a blowing force so that the air is drawn into the intake;
a filter unit configured to purify the air drawn through the intake;
an outlet through which a purified air passing through the filter unit is discharged;
a dust sensor unit configured to measure a number concentration by particle size in the air; and
a control unit configured to generate filter management information of the filter unit based on the number concentration by particle size obtained from the dust sensor unit,
wherein the control unit comprises:
a number concentration acquisition unit configured to acquire the number concentration by particle size from the dust sensor unit;
an operation information acquisition unit configured to acquire operation information of the blower fan;
a dust information acquisition unit configured to acquire information on a dust amount by particle size based on the number concentration by particle size and the operation information; and
an information providing unit configured to provide the filter management information of the filter unit based on the information on the amount of dust.

2. The air purifier of claim 1, wherein the dust information acquisition unit comprises a first dust information unit configured to acquire a cumulative dust amount as the information on the amount of dust,
wherein the first dust information unit is configured to acquire the cumulative dust amount by summing a dust weight by particle size obtained using a collection efficiency by particle size.

3. The air purifier of claim 2, wherein the information providing unit comprises a first decision unit configured to provide filter management information of the filter unit based on the cumulative dust amount,
wherein the first decision unit is configured to determine whether a removal efficiency corresponding to the cumulative dust amount meets a management criterion of the filter unit.

4. The air purifier of claim 3, wherein the filter unit comprises a plurality of filters, and management information is provided for each filter,
wherein the number concentration by particle size of a first filter of the filter unit is obtained from the dust sensor unit, and the number concentration by particle size of a second filter of the filter unit is obtained based on the number concentration by particle size and the collection efficiency of the first filter.

5. The air purifier of claim 1, wherein the dust information acquisition unit comprises a second dust information unit configured to acquire real-time dust amount as the information on the amount of dust,
wherein the second dust information unit displays the real-time dust amount as a graph.

6. The air purifier of claim 5, wherein the information providing unit comprises a second decision unit configured to provide filter management information for each filter based on the real-time dust amount,
wherein the second decision unit is configured to extract a specific section from the graph of the real-time dust amount and to provide management information of the filter unit.

7. The air purifier of claim 6, wherein the second decision unit is configured to select a specific particle in the extracted specific section, to calculate purification capacity for the specific particle based on reference data, and to provide the management information of the filter unit.

8. A method for deciding a filter state of an air purifier, the method comprising:
acquiring a number concentration by particle size from a dust sensor unit;
receiving operation information of a blower fan;
acquiring information on a dust amount by particle size based on the number concentration by particle size and the operation information; and
providing management information of a filter unit based on the information on the dust amount.

9. The method of claim 8, wherein acquiring the number concentration by particle size comprises:
acquiring the number concentration by particle size of a first filter of the filter unit from the dust sensor unit;
receiving information on collection efficiency of the first filter; and
acquiring the number concentration by particle size of a second filter of the filter unit based on the number concentration by particle size and the collection efficiency of the first filter.

10. The method of claim 9, wherein the first filter comprises a pre-filter, the second filter comprises a functional filter, and a third filter comprises a dust-collecting filter.

11. The method of claim 8, wherein acquiring the information on the dust amount comprises acquiring a cumulative dust amount as the information on the dust amount.

12. The method of claim 11, wherein acquiring the information on the dust amount comprises:
acquiring a mass concentration by particle size from the number concentration by particle size;
acquiring an inflow weight by particle size, considering the operation information of the blower fan;
acquiring a dust weight by particle size reflecting the collection efficiency from the inflow weight by particle size; and
acquiring the cumulative dust amount from the dust weight by particle size.

13. The method of claim 12, wherein acquiring the inflow weight by particle size comprises considering airflow and operation time as the operation information of the blower fan.

14. The method of claim 12, wherein acquiring the dust weight by particle size comprises applying pre-stored collection efficiency by particle size to the inflow weight by particle size.

15. The method of claim 12, wherein acquiring the cumulative dust amount comprises summing the dust weight by particle size derived for each particle to obtain the cumulative dust amount.

16. The method of claim 8, wherein providing the filter management information for each filter comprises applying pre-stored removal efficiency corresponding to the cumulative dust amount to obtain a removal efficiency of each filter from the acquired cumulative dust amount.

17. The method of claim 8, wherein acquiring the information on the dust amount comprises acquiring a real-time dust amount as the information on the dust amount.

18. The method of claim 17, wherein providing the filter management information for each filter comprises:
extracting a decrease section from a graph of the real-time dust amount;
selecting a target particle from the decrease section;
calculating purification capacity based on a decrease state of the selected particle; and
providing the filter management information based on the purification capacity.

19. The method of claim 18, wherein extracting the decrease section comprises extracting a decrease section having a specific learned trend from the graph of the real-time dust amount.

20. The method of claim 18, wherein selecting the target particle comprises applying a learned result regarding a method of selecting a target particle from the decrease section.

21. The method of claim 18, wherein calculating the purification capacity comprises regarding an initially measured purification capacity as reference data, and calculating the purification capacity at a selected time compared to the reference data.

22. The method of claim 21, wherein the purification capacity (P) is calculated by the following Equation (4):
$$P = \frac{V}{{N}_{t}} ln ( \frac{{C}_{i 2}}{{C}_{t 2}} ) - ln ( \frac{{C}_{i 1}}{{C}_{t 1}} ) \qquad Equation ( 4 )$$
where V is the volume of clean air in the installation space of the air purifier, Nₜ is the total number of particles during the operation period of the air purifier, Cᵢ₁ is the particle concentration before starting the operation of the air purifier, Cᵢ₂ is the particle concentration after starting the operation, Cₜ₁ is the time before starting the operation, and Cₜ₂ is the time after starting the operation.
